(19) United States
(12) Patent Application Publication
(10) Pub. No.: US 2015/0362620 A1
(43) Pub. Date: Dec. 17, 2015

(54) Intelligent Management of Data Acquisition

(71) Applicant: Schlumberger Technology Corporation, Sugar land, TX (US)

(72) Inventor: Vishwanathan Parmeshwar, Roissy-en-France (FR)

(21) Appl. No.: 14/303,600

(22) Filed: Jun. 13, 2014

(51) Int. Cl. G01V 13/00

(52) U.S. Cl. CPC G01V 13/00

(57) ABSTRACT

A data acquisition system that includes an acquisition software module having a memory device, and a measurement device that includes sensor interface modules and sensors is provided. The acquisition software module is operatively connected to the measurement device. The data acquisition system is disposed at some desired location and data is acquired. Acquiring data includes performing an operation such as auto-resend, auto-save, and auto-recovery. The measurement device may also include a front end acquisition module and field boxes. The sensor interface modules may provide the state of each sensor, detect disconnection of any sensor, and/or detect a fault state for any sensor. The acquisition software module may determine the states of certain components of the data acquisition system. The acquisition software module can receive topology data from the measurement device and store the data into its memory device. The acquired data may be monitored in real-time while operations are performed.

### BACKGROUND

In any surface measurement system, acquisition plays an important role in how such a system is administered or managed. Typically, most systems have a central logic control to which all the sensors are cabled (wired). The central logic control is, among other things, used to calibrate the signal received from the sensors to appropriate physical values. This is generally done by digitizing the signal and then associating the digital information to a calibration value. The calibration value depends, at least in part, on the type and range of each sensor. The central logic control stores the calibration values in memory so that when the measurement system is restarted after a shutdown, the retained calibration values may be used again. Each type of sensor, such as a voltage-based sensor, a current-based sensor, or a digital proximity sensor is typically connected to a corresponding module in the central logic control, and the central logic control is configured appropriately. In case of any change of the modules (e.g., due to a component failure), the substitute module must be physically configured before resuming operations. This is usually a time-consuming process that requires a skilled technician trained to manage the system. Also, if a module fails, there is a permanent loss of data until the module is replaced.

Several programmable central logic controls are commercially available that acquire data using cyclical algorithms. In addition to such programmable central logic controls, there are several readily available modules that conform to different industry-standard protocols. FIG. 1A schematically shows an example of a prior art field bus system comprising a central concentrator (collectively, an acquisition software module 102 and a front end acquisition module 104) and satellite field boxes 106. Each piece of equipment may be uniquely identified by an identification number embedded into the equipment (UID) and the whole field bus system may be managed through the front end acquisition module 104. The deployed field boxes 106 act as nodes through which data enters the data bus system. Each field box 106 contains a sensor interface module 108 that facilitates connection of sensors 110. The sensor interface modules 108 contain channels that can be individually programmed to connect various types of sensors 110. After connecting a sensor 110, a calibration value may be loaded by the front end acquisition module 104 via sensor interface module 108. Data from sensor 110 is digitized with the calibration value before entering the data bus stream.

The location of the each piece of equipment (e.g., each field box 106 or sensor interface module 108) in the field bus system may be verified by checking its UID. For example, upon changing the position of any sensor interface module 108 in the field bus system, the sensor interface module 108 broadcasts its location to the concentrator. Thus, the entire field bus topology can be viewed, along with the position of the sensor interface module 108 and its connected sensors 110. Each connection of a sensor 110 is mapped to a measurement channel, and data arriving from the given channel is stored against that measurement channel identifier.

### SUMMARY

A data acquisition system that includes an acquisition software module having a memory device, and a measurement device that includes sensor interface modules and sensors is provided. The acquisition software module is operatively connected to the measurement device. The data acquisition system is disposed at some desired location and data is acquired. Acquiring data includes performing an operation such as auto-resend, auto-save, and auto-recovery. Those operations need not be performed simultaneously or in conjunction with one another. Each can be performed independently depending, for example, on what conditions are encountered. The acquisition software module can receive topology data from the measurement device and store the data in its memory device. The acquired data may be monitored in real-time while operations are performed.

The auto-send operation may comprise:

receiving by the acquisition software module topology data from the measurement device;
comparing archived topology data stored in the memory device of the acquisition software module to the topology data received from the measurement device; and
if differences are detected, sending data regarding topology to the measurement device.

The auto-save operation may comprise:

receiving by the acquisition software module topology data from the measurement device;
storing in the memory device of the acquisition software module the received topology data;
changing the configuration of the measurement device to produce modified topology data; and
storing in the memory device of the acquisition software module the modified topology data along with the received topology data already stored therein.

The auto-recovery operation may comprise:

restarting the acquisition software module;
receiving by the acquisition software module time bounds of data stored within a memory module of the measurement device;
comparing archived data stored in the memory device of the acquisition software module to the time bounds information received from the memory module of the measurement device; and
upon finding missing data in the archived data, transferring the data associated with those time bounds.

The measurement device and the software acquisition module may be physically separated and powered by the same or different power sources. The measurement device may also comprise a front end acquisition module and/or one or more field boxes, each of the components of the measurement device being operatively connected to at least one other of those components. The front end acquisition module may act as an interface for communication between the components of the measurement device and the acquisition software module. Data regarding the topology may be transmitted via a single resend command from the acquisition software module to the front end acquisition data and the front end acquisition module may dispatch it to the corresponding component. Data regarding the topology of the field bus system may comprise data regarding its configuration and the mapping of the sensors to their respective measurement channels, and/or data regarding the calibration of the sensors.

The disclosure applies to and is described in the context of the oil and gas industry, but is not so limited. For example, the sensors of the measurement device may be used to measure several parameters related to a drilling rig in order to monitor the well construction and are deployed at least in one location on the rig. Indeed, the process of drilling an oil well is very complicated, with several operations running concurrently. To regulate and manage these operations, several sensors are deployed at various locations at the well site. They provide vital information for monitoring the well construction process in real-time, thereby effecting a safe and timely completion of the well. Since the physical locations of these sensors are distributed over a wide area at the rig site, a field bus system is deployed that not only energizes the sensors, but also aids in transporting the information (signal and/or data) back to a central processing unit. However, while that example focuses on an oil and gas application, embodiments described herein are equally adaptable and useful in settings other than oil and gas.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. Embodiments of determining are described with reference to the following figures. The same numbers are generally used throughout the figures to reference like features and components.

FIG. 1A is a schematic drawing showing elements of a prior art field bus or data acquisition system.

FIG. 1B is a schematic drawing showing a data acquisition system according to one or several embodiments of the disclosure.

FIG. 2 is a workflow showing an embodiment of the auto-resend mode, in accordance with the present disclosure.

FIG. 3 is a workflow showing an embodiment of a multi-level uploading mode, in accordance with the present disclosure.

FIG. 4 is a workflow showing an embodiment of the auto-save mode, in accordance with the present disclosure.

FIG. 5 is a workflow showing an embodiment of the auto-recovery mode, in accordance with the present disclosure.

FIG. 6 is a sequence diagram for an embodiment employing the auto-resend mode, in accordance with the present disclosure.

FIG. 7 is a sequence diagram for an embodiment employing the auto-save mode, in accordance with the present disclosure.

FIG. 8 is a sequence diagram for an embodiment employing a multi-level uploading mode for which the front end acquisition module is the chosen node, in accordance with the present disclosure.

FIG. 9 is a sequence diagram for an embodiment employing a multi-level uploading mode for which a field box is the chosen node, in accordance with the present disclosure.

FIG. 10 is a sequence diagram for an embodiment employing a multi-level uploading mode for which a sensor interface module is the chosen node, in accordance with the present disclosure.

FIG. 11 is a sequence diagram for an embodiment employing the auto-recovery mode, in accordance with the present disclosure.

### DETAILED DESCRIPTION

It is to be understood that the following disclosure provides many different embodiments, or examples, for implementing different features of various embodiments.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Some embodiments will now be described with reference to the figures. Like elements in the various figures may be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship, as appropriate. It will also be understood that, although the terms first, second, etc. may be used herein to describe various elements, these elements should not be limited by these terms. These terms are only used to distinguish one element from another.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

A system and method to increase the reliability of a field bus system, reduce the time required to execute various workflows for the field bus system, and to make the field bus system more autonomous are described herein. A field bus system may have several sensors deployed for making measurements. These sensors may be deployed at different locations on a drilling rig, at the surface, so the acquisition system is able to monitor the drilling of a well. The sensors can measure different parameters related to the drilling rig, such as depth, volume, weight, temperature, pressure, voltages, currents, impedances, forces, torques, etc. When managing several sensors in a field bus system, setting up, calibrating, and managing each sensor is time-consuming work. A field bus system may support sensors that can be connected on programmable channels that provide data loss recovery and can minimize the time needed for configuring, both at startup and during technical intervention. The sensor interface module 108 may be adapted to give the state of each sensor 110 and to detect disconnection of the sensor 110, along with a fault state. An acquisition software module 102, on identifying the presence of a front end acquisition module 104, may determine the states of various equipment operatively connected (e.g., wired or wireless) to the front end acquisition module 104 and autonomously upload the required information into the front end acquisition module 104.

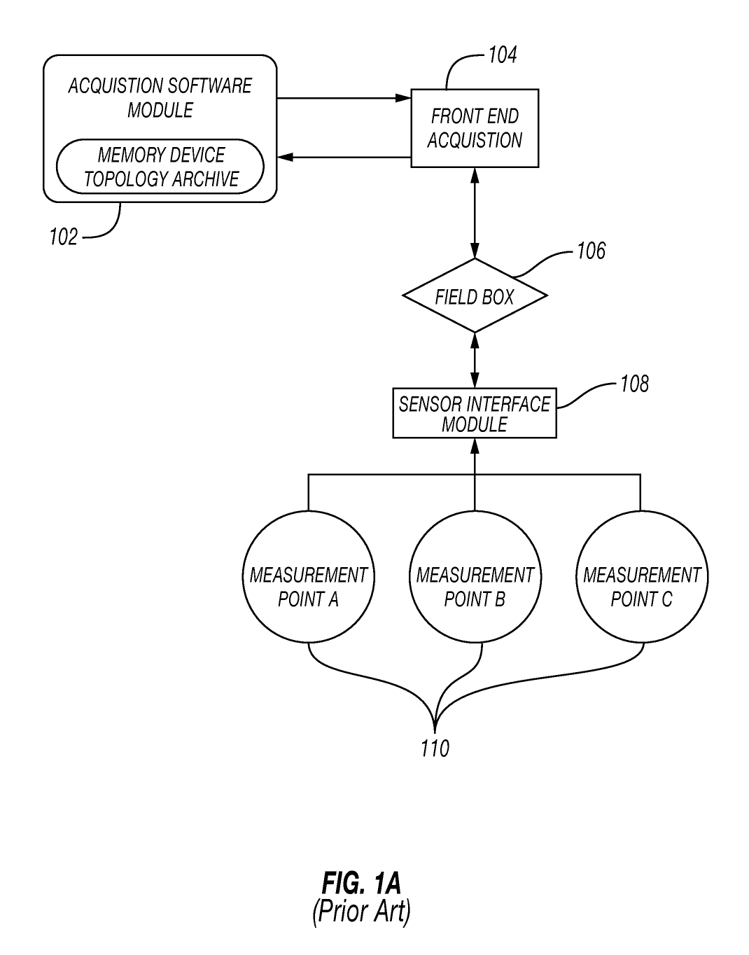

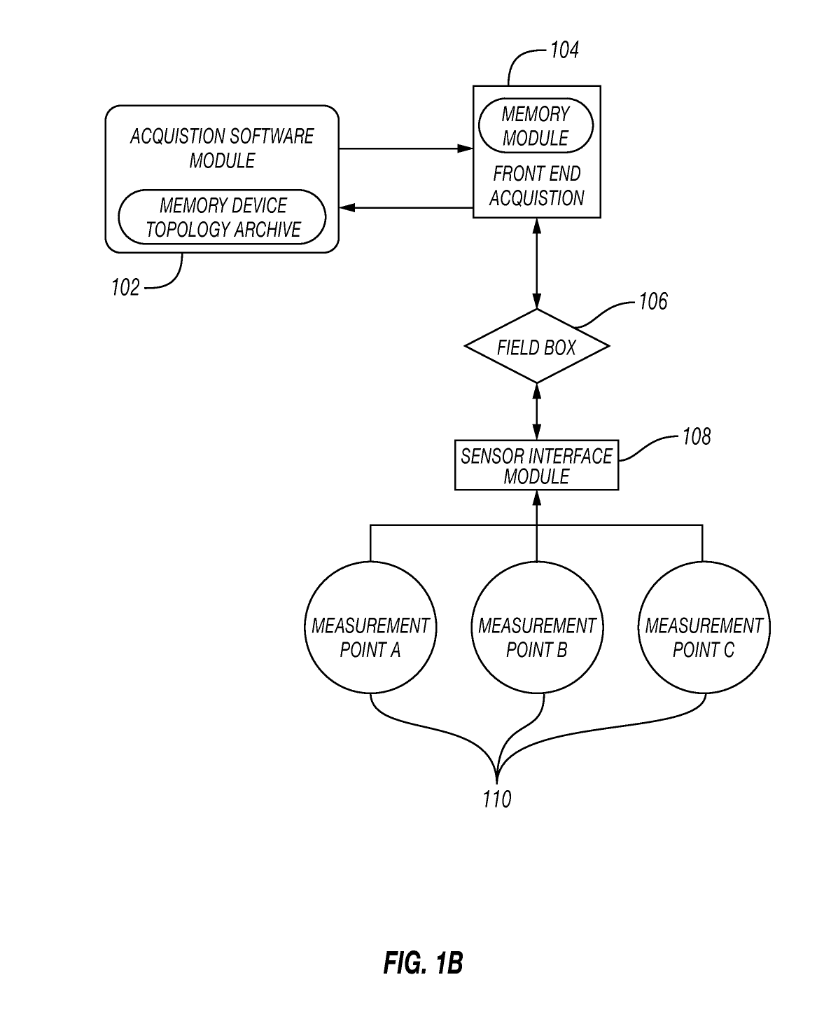

The front end acquisition module 104 may act as a staging place for all commands emanating from the acquisition software module 102 and then execute those commands It also receives all the data sent by the field boxes 106 that are generated by the sensors 110 and synchronizes the data before sending it to the acquisition software module 102. A modifiable memory device, which is more particularly a non-volatile memory device, is embedded in the acquisition software module 102. Another modifiable memory module may be embedded in the front end acquisition module 104 and can store data acquired by the measurement device. This memory module may be volatile and/or non-volatile. The acquisition software module 102 and the front end acquisition module 104 may comprise two processors that are physically separated and powered by the same or different power sources. An acquisition system according to one or more embodiments of this disclosure, particularly those embodiments having a memory module embedded in the front end acquisition module 104, is shown in FIG. 1B.

A data acquisition system generally acquires information that may be used to monitor real-time activity or archived for later analysis. Since deploying a data acquisition system often involves lost production time, an operator of a data acquisition system generally seeks to minimize the time required to initially configure it. In addition, because loss of data is manifestly undesirable for a data acquisition system, it follows that the operator of a data acquisition system generally seeks to minimize the time required to re-configure the system after recovering, for example, from a component failure. Information pertinent to each sensor may be saved so that such information may be used to configure all the sensors connected into the field bus system, resulting in reduced setup time and quick intervention for any replaced sensor.

At an early stage of installation of the field bus system, topology data without any sensor input may be displayed to a user. Acquisition software module 102 receives from front end acquisition module 104 the location of the various field boxes 106 available in the field bus system, along with their UIDs and the number of sensor modules 108 deployed in field boxes 106. The user may associate a sensor with a measurement channel on at least one sensor interface module 108 deployed in the field bus system and calibrate the sensor as explained above. After associating the sensors with their respective measurement channels, the completed topology data is archived in the memory device of software acquisition device 102. Archived topology information (or data) then comprises data regarding the system configuration, the mapping of each sensor (and its corresponding UID) to its respective measurement channel, and data regarding the calibration of the sensors.

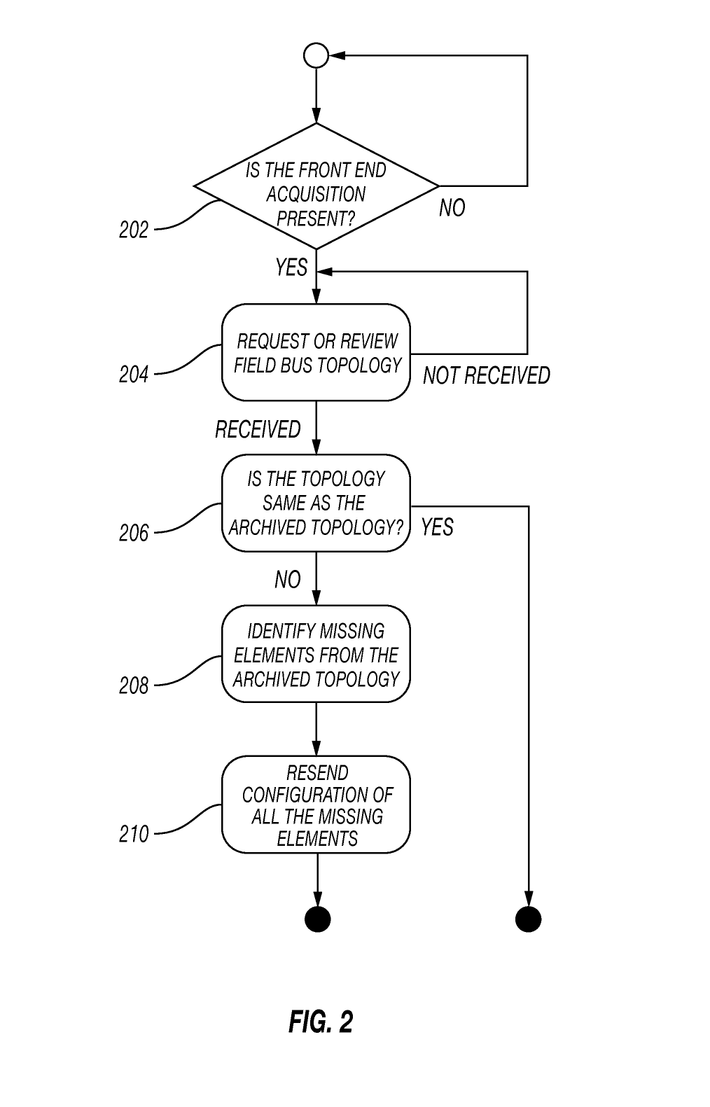

In one embodiment (shown in FIG. 2), when the entire system is to be restarted or upon failure of a measurement device or front end acquisition module 104, acquisition software module 102 (e.g., FIG. 1B) may query to see if a front end acquisition module 104 (e.g., FIG. 1B) is present (FIG. 2, 202). If so, either a request is issued to front end acquisition module 104 for topology and measurement point information (FIG. 2, 204) or the data stream of front end acquisition module 104 is reviewed. The acquisition software module 102 then receives from front end acquisition module 104 the location of the various field boxes 106, sensor interfaces 108, and sensors 110 available in the field bus system, along with their UIDs and the topology data related to those components. On receiving the topology data, acquisition software module 102 compares archived topology data to the data stream coming from front end acquisition module 104 to see if the received topology data differ from the stored (archived) topology data (FIG. 2, 206). If differences are detected (FIG. 2, 208), acquisition software module 102 sends the data regarding topology, and more particularly configuration information and/or calibration data, to front end acquisition module 104 so that missing measurement points may be created or measurement points may be re-configured (FIG. 2, 210).

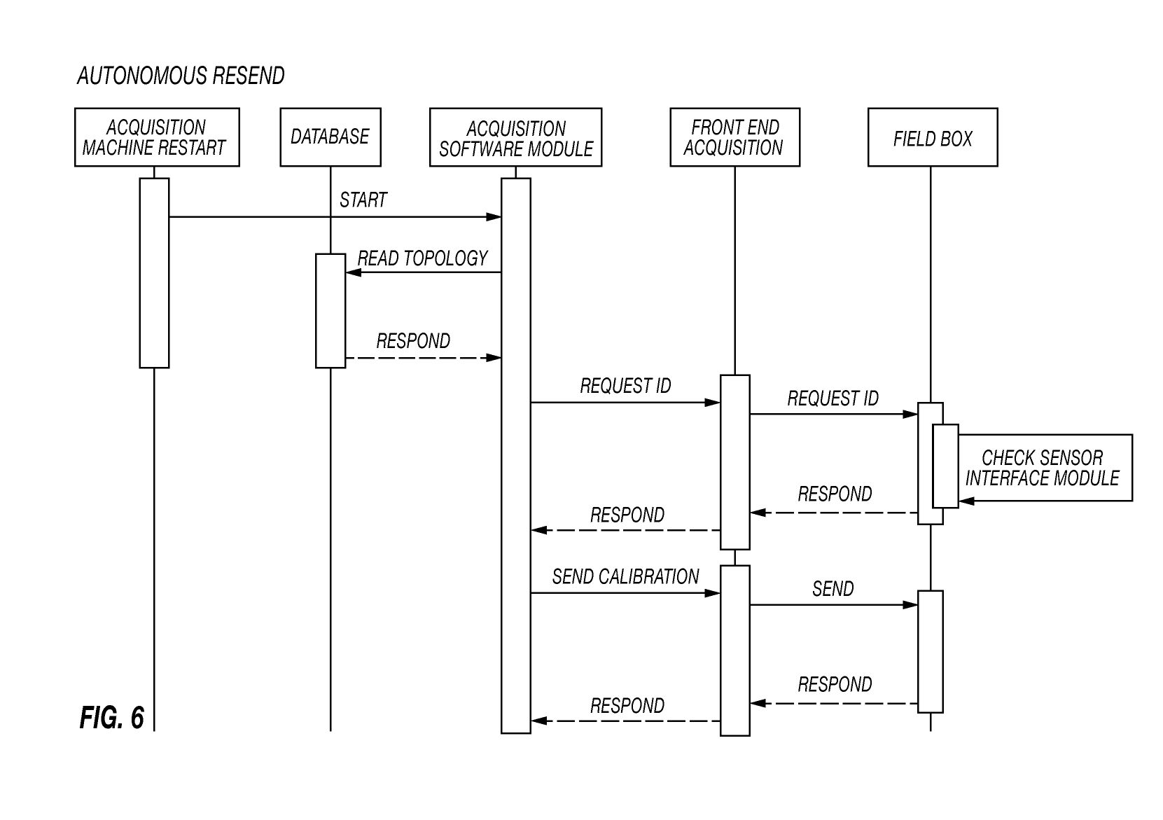

This enables the system to return to the same state it was in before the system was restarted (i.e., provides “persistence of state”), resulting in minimization of time as well as relieving the user from having to perform system readiness operations. This operational embodiment is referred to herein as an “autonomous-resend” or “auto-resend” mode. Calibration values and other configurable parameters of the sensors distributed throughout the field bus system can be transmitted via a single “resend” command from the acquisition software module 102. Part or all of the data stored in the memory device of the acquisition software module 102 may be sent indirectly or directly to the measurement device. In one embodiment, only the data regarding components for which differences have been detected, and more particularly missing data, are sent during the auto-resend mode. FIG. 6 shows one possible sequence for the auto-resend mode.

In at least one basic mode of operation, the auto re-send mode can only re-send missing data related to sensors having already been mapped and calibrated by the user. However, in an advanced mode of operation, using data archived in the memory device of the acquisition software module 102, the acquisition software module 102 may provide data for new sensors that have not previously been mapped or calibrated into the field bus system. For instance, data regarding the calibration of a predetermined type of sensors may be stored in the memory device and, upon recognition of the type of the sensor by virtue of its UID, sent to the front end acquisition module 104 to perform automatic calibration of the new sensor.

As stated above, when managing a field topology, valuable time may be lost while setting up the system and mapping the various channels to measurement points 110. In addition, a skilled operator is needed to set up the system. However, efficiency may be gained if the loading of topology data can be initiated at various levels in the topology. The field bus topology has several nodes such as front end acquisition module 104, field boxes 106, and sensor modules 108. Each of these nodes represents a hierarchy of levels, with the sensor interface modules 108 being the lowermost level where various sensors 110 are attached to the field bus. Upon accessing any node, a user may load a selected feature onto all the measurement points 110 associated with that node. This mode is referred to herein as “multi-level uploading” mode.

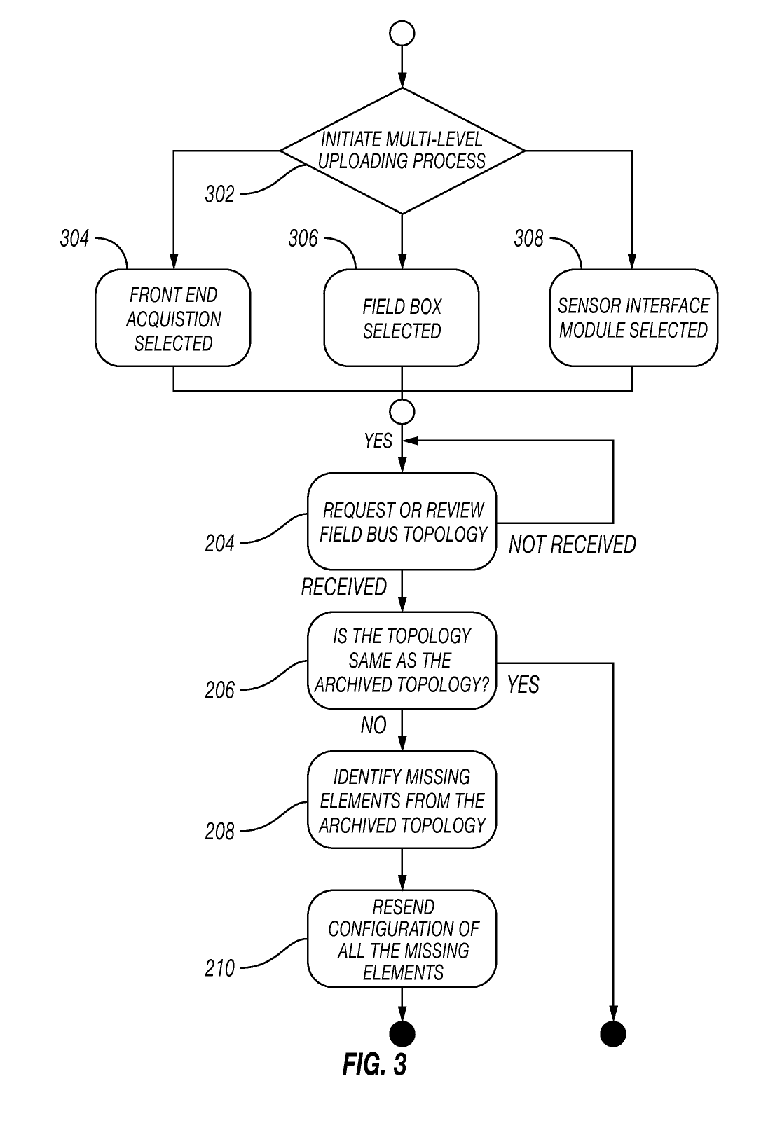

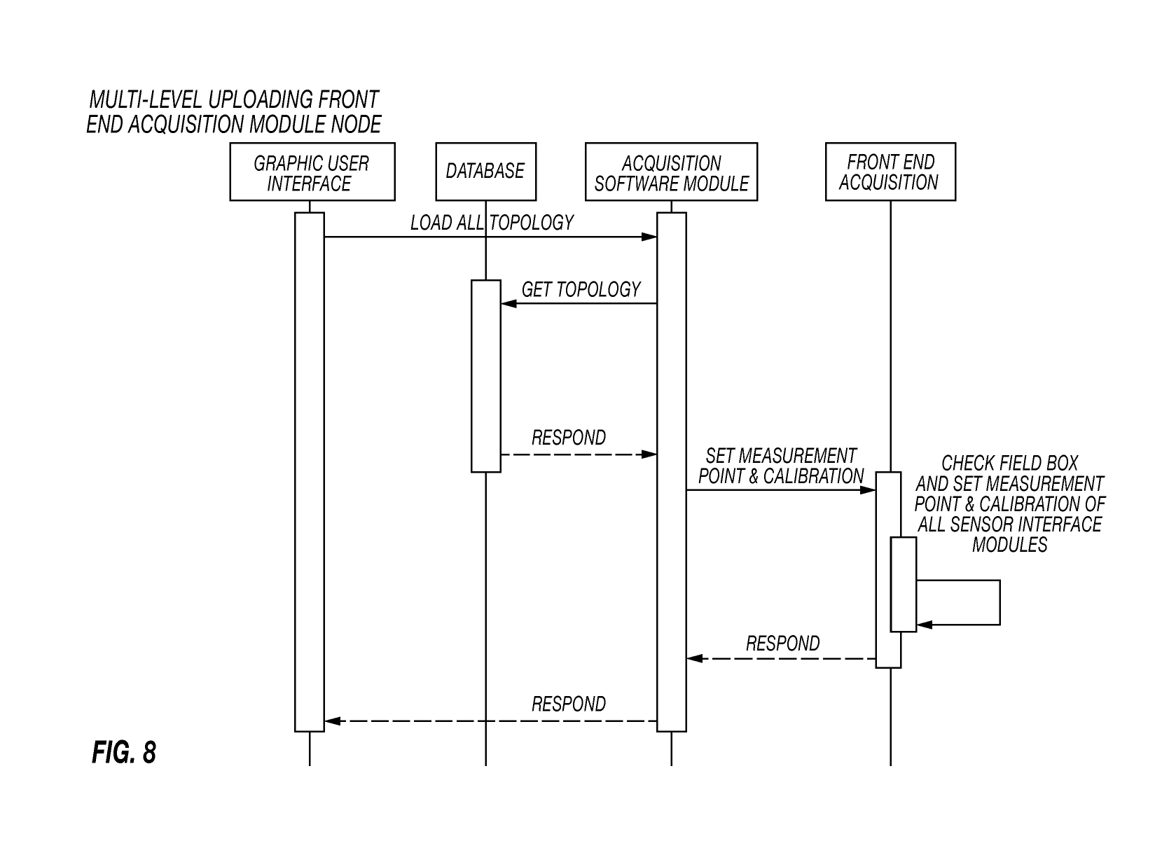

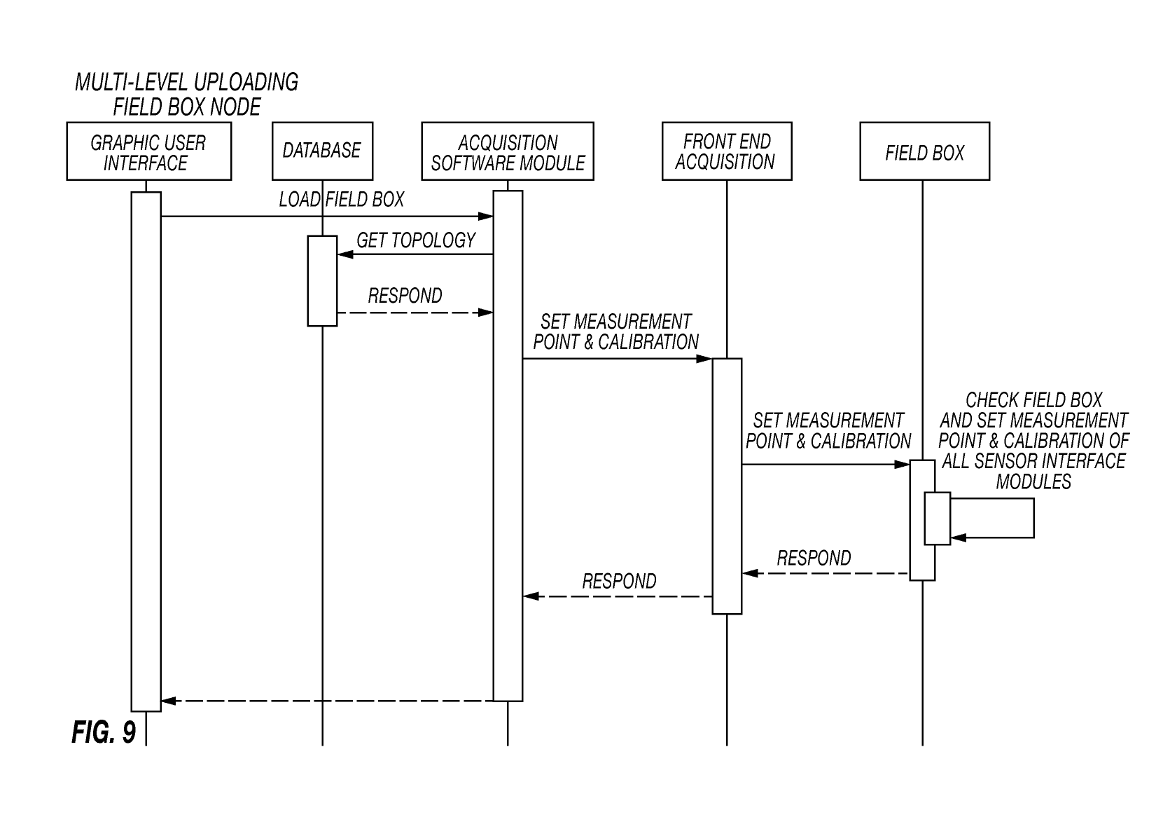

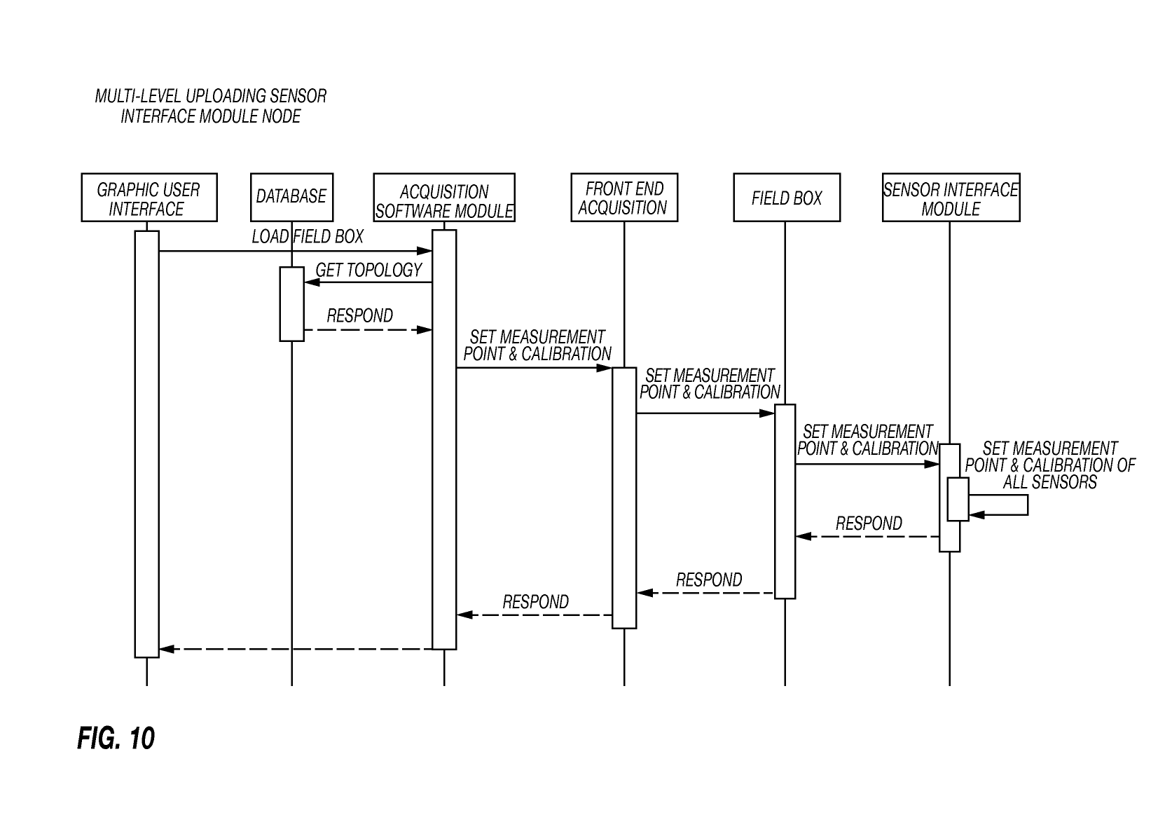

When operating in this mode, the acquisition software module 102 refers to the saved topology in the topology data archive and accordingly initiates an autonomous-resend for that node. Thus, performing multi-level uploading of measurement points at a sensor interface module 108 results in the initialization of all the sensors 110 connected to that module, while performing multi-level uploading of measurement points at a field box 106 will initialize several sensors interface modules 108 and their associated sensors 110. For a complete initialization of the field bus topology, the front end acquisition module 104 may be initialized. This reduces the time required for initialization of the system and also provide a means whereby several systems for which the layout of the measurement points 110 are the same may be initialized using a single saved topology. An example of multi-level uploading of measurement points is shown in FIG. 3. Upon initialization (302), a node such as the front end acquisition module (304), a field box (306), or a sensor interface module (308) is selected. After node selection, one may proceed as above for an auto-resend (FIG. 2, 204, 206, 208, 210). FIG. 8 shows one possible sequence for the multi-level uploading mode for which the front end acquisition module is the chosen node; FIG. 9 shows one possible sequence for the multi-level uploading mode for which a field box is the chosen node; and FIG. 10 shows one possible sequence for the multi-level uploading mode for which a sensor interface module is the chosen node.

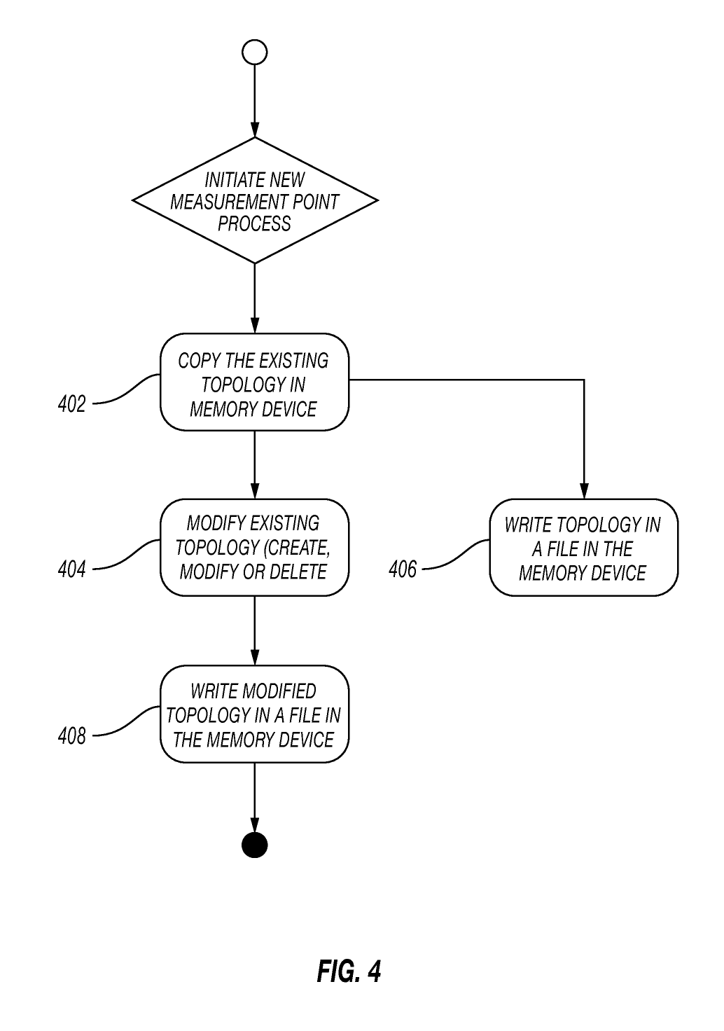

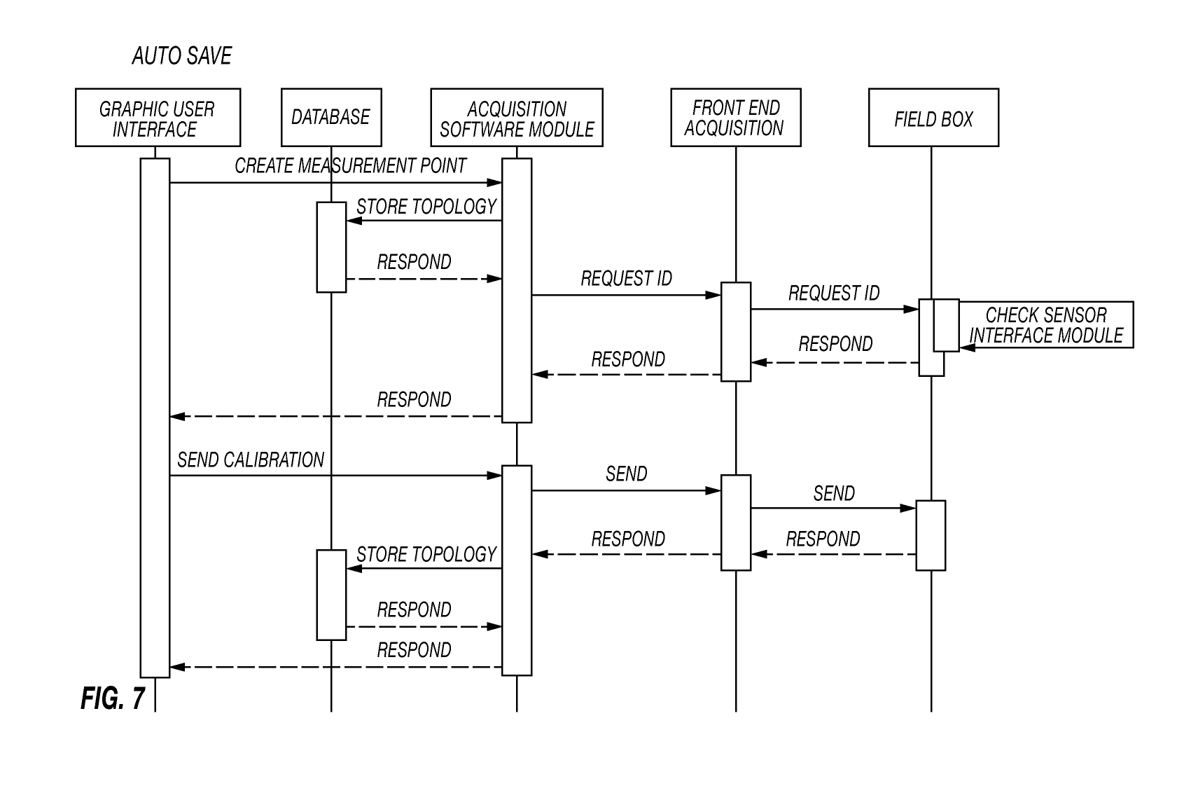

A further embodiment is shown in FIG. 4 and referred to herein as “auto-save” mode. In the auto-save operational mode, acquisition software module 102 receives from front end acquisition module 104 the location of the various field boxes 106 available in the field bus system, along with their UIDs and the number of sensor modules 108 deployed in field boxes 106 (FIG. 4, 402) and store them in its memory device as explained above (FIG. 4, 406). Acquisition software module 102 allows the end-user to create measurement points 110 and map specific channels to specific sensors representing these measurement points (FIG. 4, 404). As the field bus configuration changes with the addition of measurement points 110, the field bus topology, including the measurement points and calibration values, is stored automatically (FIG. 4, 408) in the memory device associated with the acquisition software module 102. Thus, each change triggers the generation of two sets of configurations: one prior to the change in field bus topology (FIG. 4, 406) and one after the change (FIG. 4, 408). This allows a user to revert to a previous configuration to recover, for example, from a user-induced error. FIG. 7 shows one possible sequence for the auto-save mode. The auto-save mode has been disclosed herein in the context of the initialization of a system with respect to the operation of adding a sensor, but it may also be applied for each change made by a user to the topology of the field bus system (e.g., suppression of a sensor, replacement of a sensor, etc.).

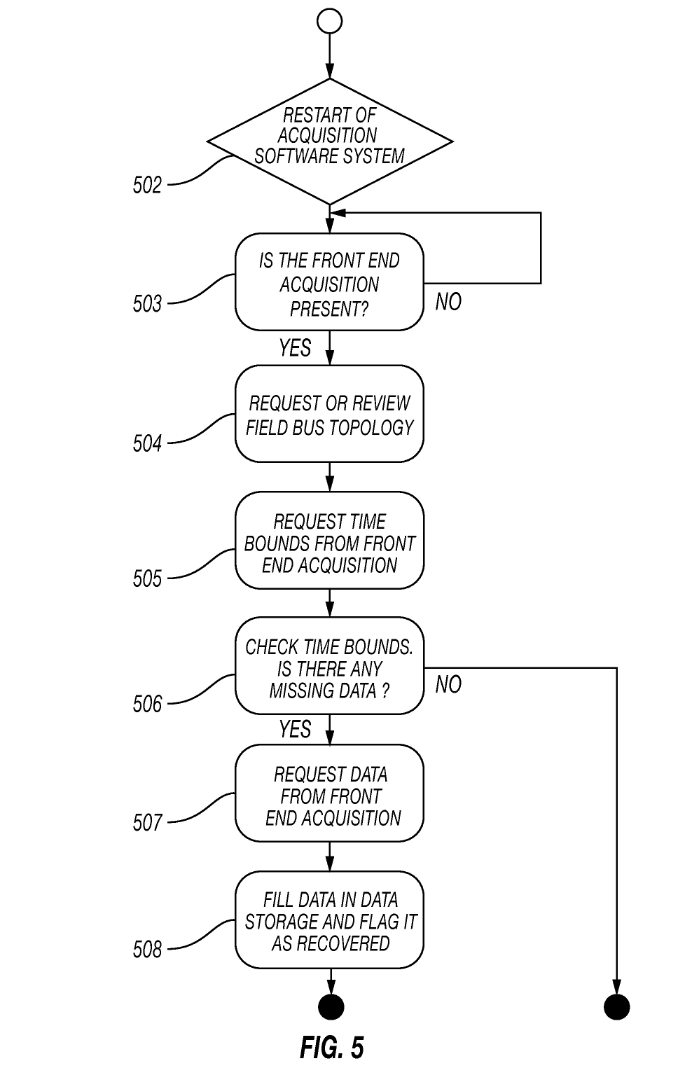

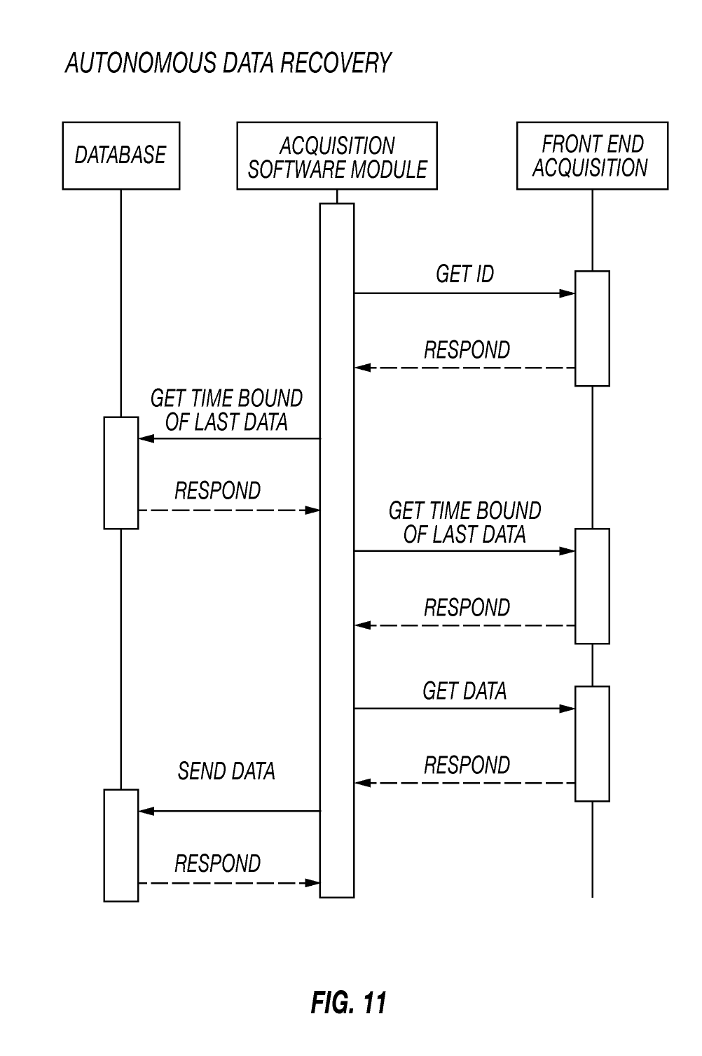

In case of an acquisition software module 102 failure, an autonomous data recovery mode may be employed. In the absence of the acquisition software module 102 (i.e., between the failure of the acquisition software module 102 and its restarting), the front end acquisition module 104 diverts the data that would normally be stored in the memory device associated with the acquisition software module 102 when the acquisition software module is working normally to be stored in the memory module embedded in the front end acquisition module 104. Upon restarting the acquisition software module 102 (FIG. 5, 502) and recognizing the presence of the front end acquisition module 104, the acquisition software module 102 requests or reviews the field topology (504). After comparing the received topology with the archived topology, the acquisition software module 102 requests (505) the front end acquisition module 104 to send the time bounds of the data stored in its memory module. The acquisition software module 102 verifies the time bounds with respect to the existing archived data and, upon finding missing data (a data hole) in the archived data, initiates a command to transfer the data associated with those time bounds (507). The front end acquisition module 104 sends data from its memory module along with the real-time data and the acquisition software module 102 then stores the data into the data archive, filling the data hole (508). This acquired data may be flagged as recovered data in the data archive. This mode is referred to herein as the “auto-recovery” mode and may be executed autonomously between the acquisition software module 102 and the front end acquisition module 104. This embodiment results in a seamless fail-over mechanism with continuous data even during an acquisition software module failure. FIG. 11 shows one possible sequence for the auto-recovery mode.

It should be noted that while the examples described herein make use of various possible measurement device components (e.g., front end acquisition module, field boxes, sensor interface modules), communication may be had directly between the acquisition software module 102 and the relevant and particular element that comprises the measurement device. That is, a measurement device may or may not include a front end acquisition module 104 and/or a field box 106. The acquisition software module 102 may therefore communicate directly with each sensor interface module 108. The term “measurement device” is meant to include any and/or all of those such components. Those skilled in the art may realize that the disclosure herein may also apply to measurement devices with different architectures than the one(s) disclosed herein. In addition, while the auto-recovery mode requires an auxiliary memory module such as the one shown in front end acquisition module 104 of FIG. 1B (though it could be carried on or within some other measurement device component), all other operational modes described herein may be performed equally well with the field bus system of either FIG. 1A or FIG. 1B (i.e., with or without the auxiliary memory module).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions, and alterations herein without departing from the scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

While only certain embodiments have been set forth, alternatives and modifications will be apparent from the above description to those skilled in the art. These and other alternatives are considered equivalents and within the scope of this disclosure and the appended claims. Although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method, comprising:
providing a data acquisition system comprising an acquisition software module having a memory device, and a measurement device that includes one or more sensor interface modules and one or more sensors connected to at least one of the sensor interface modules, the acquisition software module being operatively connected to the measurement device;
disposing the data acquisition system at some desired location; and
acquiring data using the data acquisition system, wherein acquiring data includes performing at least one operation selected from the group consisting of an auto-resend, an auto-save, and an auto-recovery.

2. The method of claim 1, wherein the measurement device further comprises a front end acquisition module and/or one or more field boxes, each of the components of the measurement device being operatively connected to at least one other of those components.

3. The method of claim 1, wherein the auto re-send operation comprises:
receiving by the acquisition software module topology data from the measurement device;
comparing archived topology data stored in the memory device of the acquisition software module to the topology data received from the measurement device; and
if differences are detected, sending data regarding topology to the measurement device.

4. The method of claim 3, wherein the data regarding topology concerns the components of the measurement device for which differences are detected.

5. The method of claim 3, wherein the measurement device further comprises a front end acquisition module, each of the components of the measurement device being operatively connected to at least one other of those components, and wherein the data regarding topology are transmitted via a single resend command from the acquisition software module to the front end acquisition module of the measurement device.

6. The method of claim 3, wherein the measurement device further comprises a front end acquisition module and one or more field boxes, each of the components of the measurement device being operatively connected to at least one other of those components, and wherein a multi-level uploading mode comprises:
selecting a node from the group consisting of the front end acquisition module, the one or more field boxes, and the one or more sensor interface modules; and
for the particular node selected, performing an auto-resend for that node.

7. The method of claim 1, wherein the auto-save operation comprises:
receiving by the acquisition software module topology data from the measurement device;
storing in the memory device of the acquisition software module the received topology data;
changing the configuration of the measurement device to produce modified topology data; and
storing in the memory device of the acquisition software module the modified topology data along with the received topology data already stored therein.

8. The method of claim 1, wherein the auto-recovery operation comprises:
restarting the acquisition software module;
receiving by the acquisition software module time bounds of data stored within a memory module of the measurement device;
comparing archived data stored in the memory device of the acquisition software module to the time bounds information received from the memory module of the measurement device; and
upon finding missing data in the archived data, transferring the data associated with those time bounds.

9. The method of claim 1, further comprising monitoring the acquired data in real-time while performing one of the auto-resend, auto-save, or auto-recovery operations.

10. The method of claim 1, wherein the one or more sensors of the measurement device measure one or more parameters related to a drilling rig in order to monitor the well and are deployed in at least one location on the rig.

11. A method, comprising:
providing a data acquisition system comprising an acquisition software module having a memory device, and a measurement device that includes one or more sensor interface modules and one or more sensors connected to at least one of the sensor interface modules, the acquisition software module being operatively connected to the measurement device;
disposing the data acquisition system at some desired location;
receiving by the acquisition software module topology data from the measurement device;
storing in the memory device of the acquisition software module the received topology data;
acquiring data using the data acquisition system, wherein acquiring data includes performing at least one operation selected from the group consisting of an auto-resend, an auto-save, and an auto-recovery.

12. The method of claim 11, wherein the measurement device further comprises a front end acquisition module and/or one or more field boxes, each of the components of the measurement device being operatively connected to at least one other of those components.

13. The method of claim 11, wherein the auto re-send operation comprises:
comparing archived topology data stored in the memory device of the acquisition software module to the topology data received from the measurement device; and
if differences are detected, sending data regarding topology to the measurement device.

14. The method of 13, wherein the measurement device further comprises a front end acquisition module and one or more field boxes, each of the components of the measurement device being operatively connected to at least one other of those components, and wherein a multi-level uploading mode comprises:
selecting a node from the group consisting of the front end acquisition module, the one or more field boxes, and the one or more sensor interface modules; and
for the particular node selected, performing an auto-resend for that node.

15. The method of claim 11, wherein the auto-save operation comprises:
receiving by the acquisition software module topology data from the measurement device;
storing in the memory device of the acquisition software module the received topology data;
changing the configuration of the measurement device to produce modified topology data; and
storing in the memory device of the acquisition software module the modified topology data along with the received topology data already stored therein.

16. The method of claim 11, wherein the auto-recovery operation comprises:
restarting the acquisition software module;
receiving by the acquisition software module time bounds of data stored within a memory module of the measurement device;
comparing archived data stored in the memory device of the acquisition software module to the time bounds information received from the memory module of the measurement device; and
upon finding missing data in the archived data, transferring the data associated with those time bounds.

17. The method of claim 11, further comprising monitoring the acquired data in real-time while performing one of the auto-resend, auto-save, or auto-recovery operations.

18. The method of claim 11, wherein the one or more sensors of the measurement device measure one or more parameters related to a drilling rig in order to monitor the well and are deployed at least in one location on the rig.

19. A data acquisition system comprising an acquisition software module having a memory device, and a measurement device that includes one or more sensor interface modules and one or more sensors connected to at least one of the sensor interface modules, the acquisition software module being operatively connected to the measurement device, the data acquisition system further comprising a means for performing at least one operation selected from the group consisting of an auto-resend, an auto-save, and an auto-recovery.

20. A non-transitory, computer-readable storage medium, which has stored therein one or more programs, the one or more programs comprising instructions, which when executed by a processor, cause the processor to perform a method comprising:
acquiring data using a data acquisition system, wherein the data acquisition system comprises an acquisition software module having a memory device, and a measurement device that includes one or more sensor interface modules and one or more sensors connected to at least one of the sensor interface modules, the acquisition software module being operatively connected to the measurement device; and wherein the acquiring data includes performing at least one operation selected from the group consisting of an auto-resend, an auto-save, and an auto-recovery.
